(19) United States
(12) Patent Application Publication
(10) Pub. No.: US 2015/0066690 A1
(43) Pub. Date: Mar. 5, 2015

(54) Method and Apparatus for On-Line Ordering

(71) Applicant: Revention, Inc., Houston, TX (US)

(72) Inventors: Sravan Manogna Joshi Vinjamuri, Katy, TX (US); Karthika Podury, Katy, TX (US)

(73) Assignee: Revention, Inc., Houston, TX (US)

(21) Appl. No.: 14/019,281

(22) Filed: Sep. 5, 2013

(51) Int. Cl. G06Q 30/06

(52) U.S. Cl. CPC G06Q 30/0633
USPC 705/26.8

(57) ABSTRACT

An application downloads and stores a list of offerings on a user's device—e.g., a restaurant's takeout menu—for selection by the user. After the user has completed the selection process (by, for example, placing items in a “basket”), he or she may proceed to “checkout” whereupon the device transmits the order to the fulfilling establishment (a restaurant, for example). A user can browse a menu or catalog and add items to their basket without constantly being connected to the Internet. The system saves the store menu (or catalog) on the user's device. When a customer logs in and selects a particular store, the system downloads the full menu (or catalog) from a file server. In this way, the system need not be connected to the Internet at all times in order for a customer to browse the offerings of the store and add items to their basket.

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

The present invention generally relates to personal electronic devices. More particularly, it relates to applications for placing on-line orders.

2. Description of the Related Art Including Information Disclosed Under 37 CFR 1.97 and 1.98

An important feature of many personal electronic devices (e.g., smartphones, tablets, notebook computers, and the like) is their ability to access the Internet via a wireless connection. Although some devices can access the Internet via the cellular telephone system using a data modem, such access typically requires a data plan from the user's cellular service provider and the usage is metered. In some areas, cellular system coverage areas are not contiguous. Accordingly, a user in transit can move into and out of coverage areas and a continuous connection to the Internet cannot be assured. Many devices offer a Wi-Fi connection to the Internet as an alternative means (or the preferred means) for connecting a personal electronic device to the Internet. However, the same problem exists for a mobile Wi-Fi user—they may move into and out of Wi-Fi “hotspots” and a continuous connection to the Internet cannot be assured. The same is likely to be true of any means for wireless data communications.

Wi-Fi is a popular technology that uses unlicensed spectrum to provide access to a local network. It allows an electronic device to exchange data or connect to the Internet wirelessly using radio waves. The Wi-Fi Alliance defines Wi-Fi as “wireless local area network (WLAN) products that are based on the Institute of Electrical and Electronics Engineers' (IEEE) 802.11 standards.” However, since most modern WLANs are based on these standards, the term “Wi-Fi” is generally used as a synonym for “WLAN”.

Many devices can use Wi-Fi, e.g. personal computers, video-game consoles, smartphones, some digital cameras, tablet computers and digital audio players. These can connect to a network resource such as the Internet via a wireless network access point. Such an access point (or hotspot) has a range of about 20 meters (65 feet) indoors and a greater range outdoors. Hotspot coverage can comprise an area as small as a single room with walls that block radio waves, or as large as many square miles achieved by using multiple overlapping access points.

In practice, a mobile device (e.g., a smartphone), may move into and out of Wi-Fi coverage as its user travels about. Thus, continuous access to the Internet is not assured. For some applications, discontinuous network access is problematic. The present invention solves this problem.

### BRIEF SUMMARY OF THE INVENTION

In one particular representative embodiment, the invention comprises an application that downloads and stores a list of offerings on a user's device—e.g., a restaurant's takeout menu—for selection by the user. After the user has completed the selection process (by, for example, placing items in a virtual shopping “cart” or “basket”), he or she may proceed to “checkout” whereupon the device transmits the order to the fulfilling establishment (a restaurant in this illustrative example).

A system according to the invention enables users to order from their favorite restaurants, stores, or the like even when they are on-the-go. Customers can login with their account information, browse the catalog or menu of their default store (or restaurant) and add items to their “cart.”

In a system according to the invention, customers can browse a menu or catalog and add items to their cart without constantly being connected to the Internet. The system saves the store menu (or catalog) on the user's device. When a customer logs in and selects a particular store, the system downloads the full menu (or catalog) from a file server. In this way, the system need not be connected to the Internet at all times in order for a customer to browse the offerings of the store and add items to their cart.

### BRIEF DESCRIPTION OF THE SEVERAL VIEWS OF THE DRAWING(S)

FIG. 1 is a schematic representation of a device according to one embodiment of the present invention.

FIG. 2 is a flow chart of a process according to an embodiment of the present invention.

### DETAILED DESCRIPTION OF THE INVENTION

The invention may best be understood by reference to the exemplary embodiment(s) illustrated in the drawing figures wherein the following reference numbers are used:

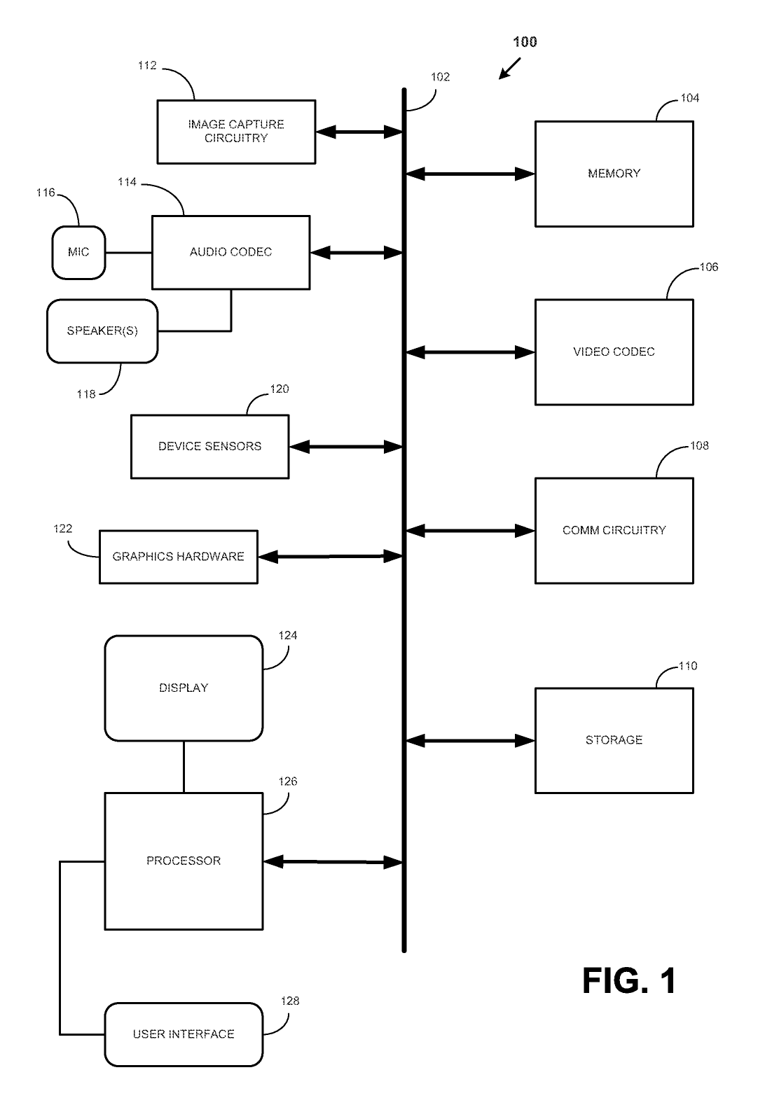

Referring to FIG. 1, a simplified functional block diagram of illustrative electronic device 100 is shown according to one embodiment. Electronic device 100 could, for example, be a smartphone, a tablet, notebook or desktop computer system. As shown, electronic device 100 may include processor 126, display 124, user interface 128, graphics hardware 122, device sensors 120 (e.g., proximity sensor/ambient light sensor, accelerometer and/or gyroscope), microphone 116, audio codec(s) 114, speaker(s) 118, communications circuitry 108, image capture circuit or unit 112, video codec(s) 106, memory 104, storage 110, and communications bus 102.

Processor 126 may execute instructions necessary to carry out or control the operation of many functions performed by device 100 (e.g., such as the processing of data obtained from device sensors 120). Processor 126 may, for instance, drive display 124 and receive user input from user interface 128. User interface 128 can take a variety of forms, such as a button, keypad, dial, a click wheel, keyboard, display screen and/or a touch screen. Processor 126 may be a system-on-chip such as those found in mobile devices and include one or more dedicated graphics processing units (GPUs). Processor 126 may be based on reduced instruction-set computer (RISC) or complex instruction-set computer (CISC) architectures or any other suitable architecture and may include one or more processing cores. Graphics hardware 122 may be special purpose computational hardware for processing graphics and/or assisting processor 126 perform computational tasks. In one embodiment, graphics hardware 122 may include one or more programmable graphics processing units (GPUs).

Image capture circuitry 112 may capture still and video images that may be processed to generate images. Output from image capture circuitry 112 may be processed, at least in part, by video codec(s) 106 and/or processor 126 and/or graphics hardware 122, and/or a dedicated image processing unit incorporated within circuitry 112. Images so captured may be stored in memory 104 and/or storage 110. Memory 104 may include one or more different types of media used by processor 126, graphics hardware 122, and image capture circuitry 112 to perform device functions. For example, memory 104 may include memory cache, read-only memory (ROM), and/or random access memory (RAM). Storage 110 may store media (e.g., audio, image and video files), computer program instructions or software, preference information, device profile information, and any other suitable data. Storage 110 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 104 and storage 110 may be used to retain computer program instructions or code organized into one or more modules and written in any desired computer programming language. When executed by, for example, processor 126, such computer program code may implement one or more of the methods described herein.

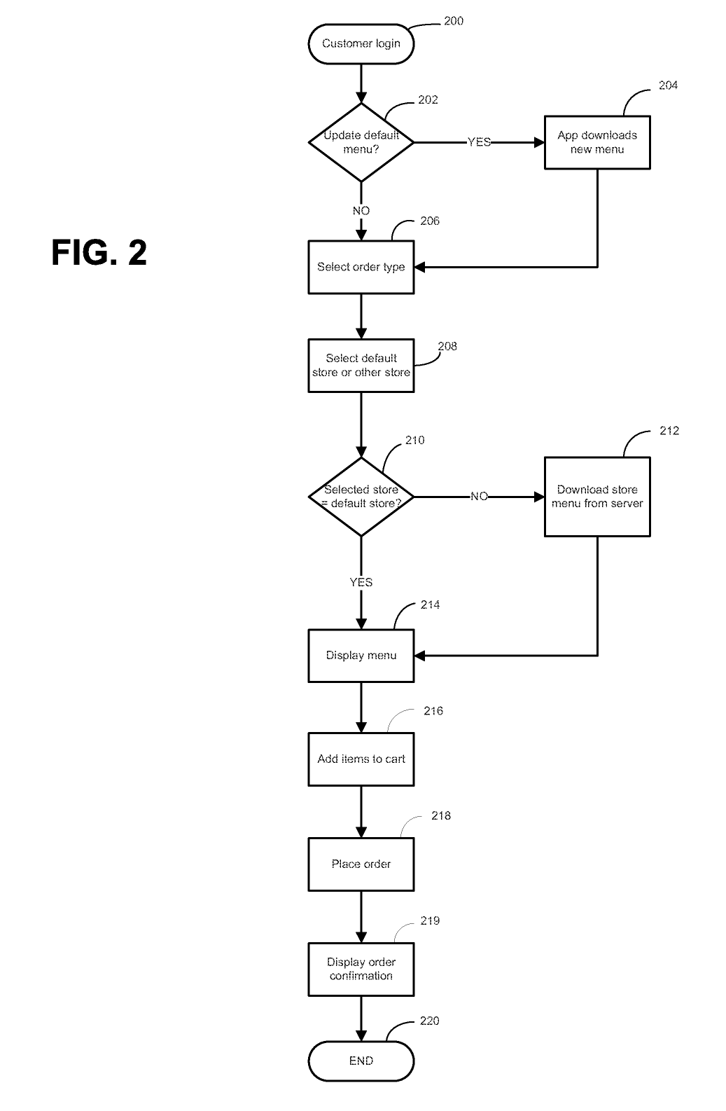

One, particular, illustrative process according to the invention is shown in flowchart form in FIG. 2.

The process may begin at 200 with the user (or “customer”) logging in to a particular merchant's website. In the illustrated example, the merchant is a restaurant having a take-out menu. It will be appreciated that other types of merchants and/or retailers offering goods and/or services in catalog or menu-style format may implement the system. The website to which the user logs in may be optimized for mobile devices. The login may include user-identifying information. The login may be a function of an application program (“app”) previously downloaded by the user. In certain embodiments, the login may be password-protected or otherwise use-restricted.

At decision diamond 202, the process may check the status of the default menu currently stored in the device. If a newer version of the menu is available (yes branch at 202), it is downloaded to the device (at 204) and replaces the default menu. A similar process may be used if no default menu is found on the device.

At 206, the user may select the type of order to be placed. For example, the order type may be an order for delivery, an order for third-party delivery (e.g., by taxi), a take-out order for pick-up, or an order for consumption on the premises. In certain embodiments, the order type may include a requested delivery time, delivery address, pick-up time, or the like. [other examples?]

If the vendor has multiple locations, the user may designate (at 208) which particular store he or she wishes to utilize for the order. Then, at decision diamond 210, the system may determine whether the selected store is the previously-designated default store for the particular user. If not (no branch at 210), the system may download a store-specific menu from a server (at 212). This process may include a determination of whether the selected store and the default store have different menus. If the stores have a common menu, no additional download is needed and step 212 may be omitted.

At 214, the (selected) menu is displayed on the user's device. In certain embodiments, the menu may have quantity selectors, cooking instructions (e.g., “rare,” “medium” or “well-done”), dressing selections (e.g., “hold the mayo”), serving instructions (e.g., dressing on the side), or the like. The menu may have hyperlinks to additional information concerning selected items (e.g., nutritional information, ingredient information, serving suggestions, photographs, reviews, etc.). A user's order may be entered by selection from a dropdown menu, “hot button,” text or any other method known in the art.

In the illustrated example, the user may (at 216) add selected items to a virtual “shopping cart” or “basket.” The user may subsequently remove previously-added items to his or her cart or add additional items prior to placing the order. In certain embodiments, the user may opt to view a display of the contents of his or her “cart.” From this display, the user may be offered the option of: 1) modifying the quantity of a particular item; 2) removing an item from the cart; 3) selecting a payment option; 4) applying a coupon to the order; 5) selecting a payment option; and/or 6) returning to a display of the menu.

It should be appreciated that processes 206, 208, 214 and 216 of the method shown in FIG. 2 may all be accomplished on the user's device without the need for a connection to the Internet. Moreover, it should be appreciated that these particular processes are the ones most likely to require the greater share of user interaction time in the ordering process. Thus, a system according to the invention minimizes the network-connection time (and data transmission) required to effect a menu-based, online transaction.

Upon “checkout,” the system may (at 218) place the user's order with the sales establishment (a particular restaurant in the illustrated example). In certain embodiments this process may include on-line payment and may be a secured transaction. At 219 the user may be notified of a successful transaction and, in certain embodiments, a confirmation e-mail (or other out-of-band message type) may be sent to the user. In the event of an unsuccessful transaction (e.g., credit card rejection, failure of connection to store, etc.), the system may display an alternative message. The process then ends at 220.

Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. A non-transitory program storage device comprising instructions stored thereon to cause one or more processors to:
determine whether a previously-stored list of items offered for on-line ordering by an establishment has been superseded by a more recent list of items offered for on-line ordering by the establishment;
download and store the more recent list of items if the previously-stored list of items has been superseded;
display the stored list of items for user selection;
store the user's selection of items;
transmit the user's selection of items to the establishment.

2. The non-transitory program storage device recited in claim 1 further comprising instructions to:
prompt the user to enter login information;
store login information input by the user; and,
transmit the user's login information to a remote system for verification.

3. The non-transitory program storage device recited in claim 1 further comprising instructions to:
display a list of order types;
prompt the user to select an order type;
store the user's selection of an order type; and
transmit the user's selection of order type to a remote system.

4. The non-transitory program storage device recited in claim 1 further comprising instructions to:
display a list of establishments;
prompt the user to select an establishment;
store the user's selection of an establishment; and
determine whether the selected establishment is associated with the stored list of items.

5. The non-transitory program storage device recited in claim 4 further comprising instructions to:
download and store a list of items specific to the selected establishment if the selected establishment is not associated with the previously-stored list of items.

6. The non-transitory program storage device recited in claim 1 further comprising instructions to:
aggregate items selected by the user;
display a list of aggregated items selected by the user; and,
prompt the user to deselect one or more items from the list of aggregated items.

7. The non-transitory program storage device recited in claim 1 further comprising instructions to:
establish a data connection to a remote system prior to determining whether a previously-stored list of items offered for on-line ordering by an establishment has been superseded by a more recent list of items offered for on-line ordering by the establishment; and
close the established data connection to a remote system prior to displaying the stored list of items for user selection.

8. The non-transitory program storage device recited in claim 5 further comprising instructions to:
establish a data connection to a remote system prior to downloading a list of items specific to the selected establishment if the selected establishment is not associated with the previously-stored list of items; and,
close the established data connection to a remote system prior to displaying the stored list of items for user selection.

9. The non-transitory program storage device recited in claim 1 wherein the establishment is a restaurant and the list of items is a menu.

10. The non-transitory program storage device recited in claim 7 wherein the instructions to establish a data connection to a remote system comprise instructions to establish a wireless data connection.

11. A processor-based system comprising:
a processor;
communications circuitry having means for wireless data communication with a remote server and in data communication with the processor; and,
a memory storing instructions for causing the processor to
determine whether a previously-stored list of items offered for on-line ordering by an establishment has been superseded by a more recent list of items offered for on-line ordering by the establishment;
download and store the more recent list of items if the previously-stored list of items has been superseded;
display the stored list of items for user selection;
store the user's selection of items;
transmit the user's selection of items to the establishment.

12. The processor-based system recited in claim 11 further comprising stored instructions for causing the processor to
prompt the user to enter login information;
store login information input by the user; and,
transmit the user's login information to a remote system for verification.

13. The processor-based system recited in claim 11 further comprising stored instructions for causing the processor to
display a list of order types;
prompt the user to select an order type;
store the user's selection of an order type; and
transmit the user's selection of order type to a remote system.

14. The processor-based system recited in claim 11 further comprising stored instructions for causing the processor to
display a list of establishments;
prompt the user to select an establishment;
store the user's selection of an establishment; and
determine whether the selected establishment is associated with the stored list of items.

15. The processor-based system recited in claim 14 further comprising stored instructions for causing the processor to
download and store a list of items specific to the selected establishment if the selected establishment is not associated with the previously-stored list of items.

16. The processor-based system recited in claim 11 further comprising stored instructions for causing the processor to
aggregate items selected by the user;
display a list of aggregated items selected by the user; and,
offer the user the options of deselecting one or more items from the list of aggregated items and modifying the quantity of one or more items on the list.

17. The processor-based system recited in claim 14 further comprising stored instructions for causing the processor to
establish a data connection to a remote system prior to determining whether a previously-stored list of items offered for on-line ordering by an establishment has been superseded by a more recent list of items offered for on-line ordering by the establishment; and
close the established data connection to a remote system prior to displaying the stored list of items for user selection.

18. The processor-based system recited in claim 15 further comprising stored instructions for causing the processor to
establish a data connection to a remote system prior to downloading a list of items specific to the selected establishment if the selected establishment is not associated with the previously-stored list of items; and,
close the established data connection to a remote system prior to displaying the stored list of items for user selection.

19. The processor-based system recited in claim 11 wherein the establishment is a restaurant and the list of items is a menu.

20. The processor-based system recited in claim 17 wherein the instructions to establish a data connection to a remote system comprise instructions to establish a wireless data connection.
